(19) United States
(12) Patent Application Publication
(10) Pub. No.: US 2008/0190446 A1
(43) Pub. Date: Aug. 14, 2008

(54) CONTROL OF DRY CLEAN PROCESS IN WAFER PROCESSING

(76) Inventors: Rajiv M. Ranade, Brewster, NY (US); Subhash B. Kulkarni, Cortlandt Manor, NY (US); Ole Krogh, Belmont, CA (US); Sukesh Patel, Cupertino, CA (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/674,218

(22) Filed: Feb. 13, 2007

(51) Int. Cl. B08B 6/00

(52) U.S. Cl. 134/1

(57) ABSTRACT

A “wafer-less” etch chamber cleaning method varies the capacitance applied to radio frequency components of the chuck that is within the etch chamber (varies impedance of the chuck) so as to cause electric field lines within the etch chamber to terminate (bend) away from the chuck. Then the etch chamber can be cleaned using a very aggressive etch chemistry (e.g., NF₃) that would otherwise damage the chuck; however, the electric field lines protect the chuck from the etch chemistry. The capacitance is varied according to a pre-established model. Further, the process evaluates the effectiveness of the pre-established model to produce feedback and constantly adjusts the pre-established model to increase the effectiveness of the cleaning process (according to the feedback).

### BACKGROUND

1. Field of the Invention

The embodiments of the invention generally relate to semiconductor wafer processing, and, more particularly to processes that clean the dry etching chamber used in semiconductor wafer processing.

2. Description of the Related Art

During semiconductor wafer processing it is common to etch the wafers in etch chambers so as to selectively remove certain materials. In order to obtain good critical dimension (CD) control for critical etch applications (such as gate etch) it is crucial that the etch chamber be returned to the same or at least some predictable state after every product wafer is processed.

The conventional methods perform dry (plasma) cleaning of the etch chamber after every product wafer is run. Commonly, the cleaning process is inconsistent or inadequate, which changes from run to run. This results in drift of the state of the chamber and in an undesirable drift of the results of product wafer processing. Undesirable high drift over time leads to significant deterioration in chamber output performance calling for drastic procedures including frequent wet-cleans and extended duration dry-cleans. The impact of such drastic measures is to make the tool state unknown, thus making it exceedingly difficult to anticipate tool output performance. Currently applied methods to bring the tool back to a stable (or at least predictable) state significantly diminish tool product output performance, significantly diminish tool uptime and tool utilization metrics, and significantly increases unit cost of devices.

### SUMMARY

In view of the foregoing, an embodiment of the invention provides a method of cleaning an etch chamber. The method is “wafer-less” because all wafers are removed from the etch chamber before the cleaning process begins. After the wafer is removed, the invention varies the capacitance applied to radio frequency components of the chuck that is within the etch chamber (varies impedance of the chuck) so as to cause electric field lines within the etch chamber to terminate (bend) away from the chuck. Then the etch chamber can be cleaned using a very aggressive etch chemistry (e.g., NF₃) that would otherwise damage the chuck; however, the electric field lines protect the chuck from the etch chemistry. The capacitance is varied according to a pre-established model. Further, the process evaluates the effectiveness of the pre-established model to produce feedback and constantly adjusts the pre-established model to increase the effectiveness of the cleaning process (according to the feedback).

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 illustrates a schematic diagram of an etch chamber; and

FIG. 2 illustrates a schematic diagram of an etch chamber.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned above, inconsistencies in the cleaning of a semiconductor wafer etching chamber tends to produce inconsistent output. Such inconsistent output may cause the wafers produced to vary enough from design parameters to be defective. One cause of this problem is the observed interaction between the product processing and the cleaning process. Typical advanced process control (APC) solutions attempt to control the product process to improve tool product output. One feature of the solution disclosed herein is the co-control of both the product and the cleaning process to optimize tool product output.

There are two types of etch reactor configurations, capacitively coupled etch reactors and inductively coupled etch reactors. The capacitively couple reactors are low to medium plasma density systems (ion density—10⁹-10¹⁰/cubic centimeter) whereas inductively coupled plasma systems are high density (ion density—10¹²/cubic centimeter). In the case of inductively coupled plasma etchers, the density of plasma is controlled by varying the current flowing through the coil in the upper electrode. For capacitively coupled plasma etchers, the density of the plasma is controlled by varying the voltage applied to the upper or lower electrode. Another important difference between these two etching systems is that in case of a capacitively coupled plasma etcher, the electric field lines are perpendicular to the lower electrode or electro-static chuck (e-chuck) where as in the case of inductively coupled plasma etchers, the plasma generated does not diffuse to the lower electrode (or to the wafer surface) until sufficient bias power or voltage is applied to the lower electrode.

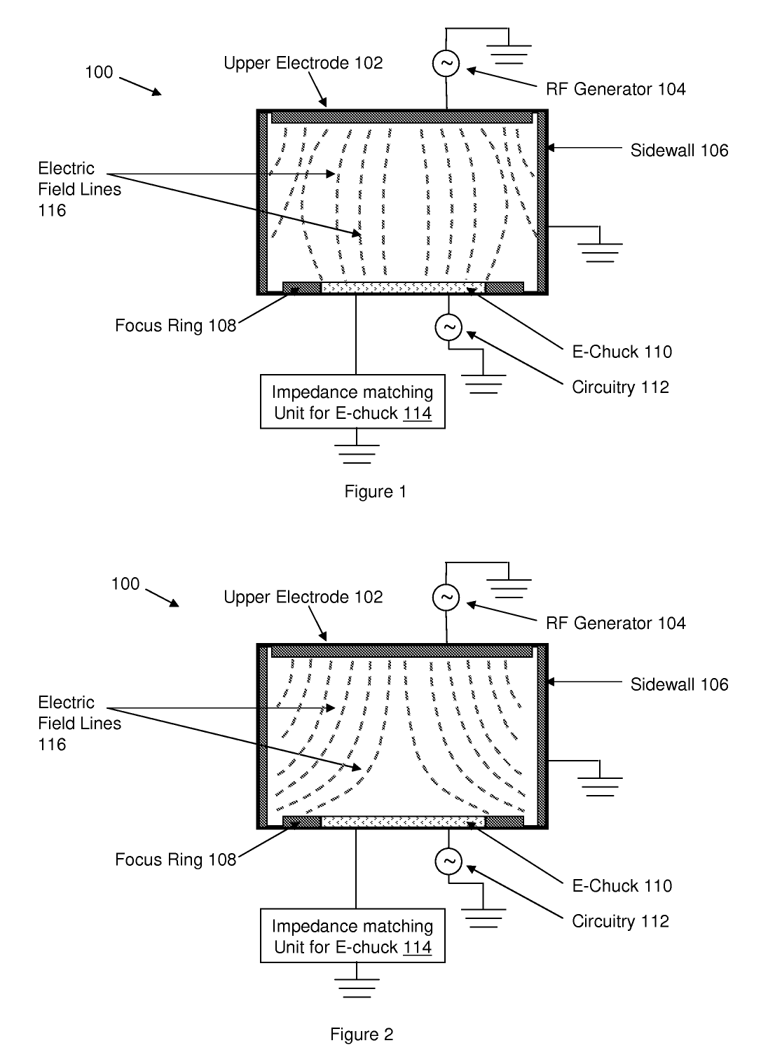

A capacitively coupled etch reactor 100 is shown in FIG. 1. It includes an upper electrode 102, an RF (radio frequency) generator 104, a grounded side wall 106, a focus ring 108, an electric chuck 110 and bottom RF generator 112, and an impedance matching unit 114 for the e-chuck 110. Note that the electric field lines 116 are mostly or essentially parallel to the side wall 106 and terminate on the electric chuck 110.

One concept disclosed herein is the alteration of the impedance within the chamber (using variable components of the RF tuning circuit 114 for the bottom electrode 110) in order to change the direction of electric field while performing wafer-less dry cleaning of the chamber. By altering the impedance, an etch chemistry can be used that offers better chamber cleaning. Thus, the embodiments herein offer improved critical dimension control for WiW, W2W, L2L and lower defect counts (PLY).

Given enough time and resources, any process chamber can be restored to a pristine state after processing a product wafer. However, concern for wafer throughput and wear and tear on the chamber hardware put severe constraints on the waferless dry cleaning process (WLDC). Some technologies apply a constant, set-it-and-forget-it WLDC process throughout the PM period, and from one PM period to the next. Ideally, the uniformity of the WLDC process should be the mirror image of the preceding product run, removing all deposits on all surfaces. Short of the ideal, in theory the WLDC process should clean only where and when the deposit has a malign effect on the next product wafer. Further, the WLDC process can be tuned to clean just the part of the process kit in need of cleaning by varying key parameters like pressure, powers, impedance, chemistry, and flows.

The present invention constructs a model of the cleaning behavior on the subject chamber of interest and then uses a model based APC to bring the chamber back to a pristine state or, if hardware conditions do not permit restoration to a pristine state, the model brings the chamber back to a predictable state which can be consistently forwarded to the APC system to produce the best output given the current state of the chamber.

If constant impedance is used during e-chuck cleaning, the user's ability to deploy aggressive WLDC chemistries that would enable to return the chamber in pristine state is severely limited. To use aggressive WLDC chemistry would necessitate the use of a wafer present on the electrostatic chuck to prevent the chuck from being damaged. On the other hand, the embodiments herein use a variable capacitance during the WLDC process that maximizes the chuck impedance, which keeps the current drawn by the e-chuck at a minimum value. Since the electric field lines are diverted away from the chuck and towards the chamber walls (or side walls) the chamber can be returned to pristine state by cleaning the side walls.

Conventional advanced process control tunes the variables in the process recipe to optimize the output on the wafer: critical dimensions, within wafer uniformity, etch microloading, and other control goals based on the incoming, pre-etch wafer by using feed forward and feedback control models. The present invention extends the process control to include the WLDC process. Thus, the results of the previous wafer or lot is the basis for determination of the etch uniformity needed in the subsequent WLDC process which is then executed with the proper choice of recipe parameters to achieve adequate cleaning on the surfaces in need thereof. This is done with feed forward and feedback models capable of controlling multiple goals simultaneously (MIMO).

Dry cleaning process are often done while there are no wafers in the etch chamber (e.g., waferless cleaning). The motivation for waferless cleaning is to reduce cost of consumables (wafers) and better thru-put. In capacitatively couple plasma systems, the electric field lines are perpendicular to the surface of the wafer (or electrostatic chuck (e-chuck)). This is illustrated by lines 116 in FIG. 1. In FIG. 1, item 100 represents the etch chamber and item 110 represents the bottom electrode.

Many different cleaning parameters can be used with the invention. In one example, a dry cleaning process can be performed using following etch chemistry: Chamber pressure=100 mT, Top Power=1500 W, Bottom Power=0 W, SF₆ flow rate=200 sccm, O2 flow rate=100 sccm, Etch time=30 sec. Note that in this example, the bottom power applied to electrostatic chuck is 0 W. In the absence of a wafer being present on the e-chuck, applying RF power to the e-chuck is likely to etch and destroy the chuck and, therefore, the power is kept to 0 W during the cleaning process. Again, this is only an example and the invention is not limited to the foregoing parameters.

Some materials used in the cleaning process present their own problems. For example, sulfur hexafluoride (SF₆) is an electro-negative gas that is often used during etching chamber cleaning. However, because SF₆ is an electro-negative gas, SF₆ can be difficult to dissociate when an RF field is applied. Therefore it is difficult to dissociate SF₆ using an RF field. This presents a problem because the presence of SF₆ tends to reduce the number of free fluorine atoms (free fluorine atoms greatly assist in the chamber cleaning process).

In the present invention, the tuning components for the bottom electrode are adjusted so that the electric field lines are deflected towards the chamber wall, rather than to the bottom electrode, to aid in the cleaning process. This is illustrated in FIG. 2 where the field lines 116 within the chamber 100 are deflected toward (terminate at) the chamber wall 106.

The use of variable impedance within the etching chamber permits the use of NF₃/O₂ chemistry as dry clean process rather than SF₆/O₂ dry clean process. The NF₃/O₂ dry clean chemistry can clean the chamber more efficiently since NF3 is easy to dissociate when RF field is applied, freeing up more fluorine which contributes to cleaning of the chamber.

In one exemplary implementation of the present invention, to deploy the multi-variable control model in conjunction with the variable chuck impedance knob, following steps are used. In this implementation, the invention executes a screening design of experiments (DOE) using the process variables used in WLDC process such as chamber pressure, gas flows, RF power, etch time etc. The objective of this screening DOE is to filter out process variables that do not have significant impact on the output of the process. The outputs of the screening DOE include rate of removal of the oxide layer and its uniformity or variation from center to edge of the wafer. For example, a 300 mm wafer with thermal oxide layer with the thickness of the oxide ranging from 1000 A to 10,000 A could be present on the electrostatic chuck during the execution of the screening design of experiments. Also, the setting for variable capacitance is set to maximize the chuck impedance (The setting for variable capacitance can also be a variable used in DOE. During the model validation run this setting will be different in order to maximize the impedance so that the current drawn by electro-static chuck is kept to a minimum value.)

During the design of experiments, a large variation is allowed for process variables. This would allow the user to map the process case for worst case. The number of experiments performed is equal to 2ⁿ where n is the number of process variables. Before the screening DOE is executed, the pre-etch oxide thickness is measured for every wafer. The wafers are then etched with pre-set process conditions. The wafers are then measured post etch for remaining thickness of the oxide and its uniformity. A pareto of important process variables is then built for the screening DOE. This pareto is defined to help narrow down number of process variables needed to designed the “control DOE”.

A second design of experiments called “Control DOE” is built using important process variables identified in the screening DOE. The number of variables in control DOE are generally less that the variables used in screening DOE. The amount of variation for control variable is smaller compared to that used in screening DOE. Again, the output of the control DOE is the rate of removal of the oxide layer and its uniformity. For example, a 300 mm wafer with thermal oxide layer with the thickness of the oxide ranging from 1000 A to 10,000 A could be present on the electrostatic chuck during the execution of the control design of experiments. Further, the setting for variable capacitance is set to maximize the chuck impedance. A model for WLDC process is then built such that the rate of oxide removal and its variation is minimized.

The embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A method of cleaning an etch chamber, said method comprising:
removing all wafers from said etch chamber;
varying a capacitance applied to radio frequency components of a chuck within said etch chamber so as to cause electric field lines within said etch chamber to terminate away from said chuck; and
cleaning said etch chamber using an etch chemistry that damages said chuck, wherein said electric field lines protect said chuck from said etch chemistry.

2. The method according to claim 1, wherein said varying of said capacitance comprises varying said capacitance according to a pre-established model.

3. The method according to claim 2, further comprising:
evaluating an effectiveness of said pre-established model to produce feedback; and
constantly adjusting said pre-established model to increase an effectiveness of said cleaning according to said feedback.

4. A method of cleaning an etch chamber, said method comprising:
removing all wafers from said etch chamber;
varying a capacitance applied to radio frequency components of a chuck within said etch chamber so as to cause electric field lines within said etch chamber to terminate away from said chuck; and
cleaning said etch chamber using NF₃ etch chemistry that damages said chuck, wherein said electric field lines protect said chuck from said NF₃ etch chemistry.

5. The method according to claim 4, wherein said varying of said capacitance comprises varying said capacitance according to a pre-established model.

6. The method according to claim 5, further comprising:
evaluating an effectiveness of said pre-established model to produce feedback; and
constantly adjusting said pre-established model to increase an effectiveness of said cleaning according to said feedback.
